(19) United States
(12) Patent Application Publication
(10) Pub. No.: US 2006/0004470 A1
(43) Pub. Date: Jan. 5, 2006

(54) Multivalue control system and method for controlling a multivalue controlled system

(75) Inventor: Klaus Lietzau, Karlsfeld (DE)

Correspondence Address: KENYON & KENYON, ONE BROADWAY, NEW YORK, NY, 10004, US

(73) Assignee: MTU AERO ENGINES GmbH, Muenchen (DE)

(21) Appl. No.: 10/530,613

(22) PCT Filed: Sep. 25, 2003
(86) PCT No.: PCT/EP03/10651

§ 371 Date: Apr. 7, 2005

(30) Foreign Application Priority Data
Oct. 8, 2002 (DE) 102 46 910.5

(51) Int. Cl. G05B 11/01

(52) U.S. Cl. 700/19; 700/20; 700/53

(57) ABSTRACT

A multivalue control system includes a controlled multivalue system, the controlled multivalue system having a plurality of correcting variables as input variables and a plurality of controlled variables as output variables. Furthermore, a plurality of comparators is provided for ascertaining control deviations. A plurality of controllers is provided, a control deviation being able to be supplied to each controller as an input variable. The multivalue control system has a correcting variable conversion device, output values made available by the controllers being able to be supplied to the correcting variable conversion device as input variables. The correcting variable conversion device ascertaining from the output variables of the controllers the correcting variables for the controlled multivalue system.

### FIELD OF THE INVENTION

The present invention relates to a multivalue control system, to a method for controlling a multivalue controlled system and to a method for controlling a propeller power unit.

### BACKGROUND INFORMATION

The starting point for control technology or for a control task is a system or a device for which a value that changes with time is to be influenced in a certain manner. The value to be controlled is designated as the controlled variable, and the given system or device is designated as the controlled system. The controlled variable is an output variable of the controlled system, and a measured value of the controlled variable is termed the actual value of same. The controlled variable is to be influenced such that the controlled variable is equal to a desired quantity, which is called the setpoint value. The real actual value of the controlled variable is compared to the desired setpoint value, the corresponding deviation, a so-called system deviation, being supplied to a controller. Based on the system deviation, the controller generates a regulating variable, the regulating variable being an input variable of the controlled system.

Frequently, controlled systems are to be controlled in which several variables that vary over time, that is, several controlled variables, are to be influenced and thereby controlled. Such controlled systems are termed controlled multivalue systems or multivalue controlled systems. Examples of such multivalue control tasks are the following:
propeller power units, such as turboprop power units for aircraft, in which the speed and the performance of a propeller are to be controlled,
distillation columns, in which the liquid level and temperatures in the bottom and the top of the column are to be controlled, or
air conditioning, in which the temperature and the humidity of a space are to be controlled.

### SUMMARY

Example embodiments of the present invention relate to such multivalue control systems or controlled multivalue systems. In the following, an example embodiment of the present invention is described with reference to the regulation of a propeller power unit. However, it should be understood that the present invention should not be considered to be limited to the regulation of a propeller power unit.

In such multivalue control systems, in general, there are interrelationships or couplings between the several controlled variables and the several correcting variables of such a kind that one correcting variable acts not only upon one but on a plurality of controlled variables. Furthermore, in general, nonlinearities occur between the several correcting variables and the several controlled variables. The interrelationships and the nonlinearities between the correcting variables and the controlled variables may pose considerable difficulties for the arrangement of a suitable controller, e.g., if an optimal control result is required over the entire operating range of the controlled system, and not only in the area of a preferred operating point of the controlled system.

In the article by Harold L. Wade, entitled “Inverted Decoupling: A Neglected Technique,” Advances in Instrumentation and Control, Instrument Society of America, Vol. 51, pp. 357 to 369 (1996), and in U.S. Pat. No. 5,403,074, a controlled multivalue system having a controlled multivalue system is described, the controlled multivalue system having several correcting variables as input variables and several controlled variables as output variables, having several comparators for ascertaining control deviations, having several controllers, to each controller one control deviation being able to be supplied as input variable, and having a conversion device whose input variables are the output variables made available by the controllers, the conversion device calculating the correcting variables for the controlled multivalue system at least from the output variables of the controllers. In the article by Axel Graeser, entitled “Cross-Profile Control in the Paper Industry—Sensors and Actuators as Determining Elements of the Control Quality,” Automatisierungstechnik (Automation Technology), Oldenbourg Verlag, Vol. 45, pp. 271 to 281 (1997), a control method is described that has decoupling of the individual loops and a compensation of the system or path coupling.

Using conventional multivalue control systems or methods for controlling a controlled multivalue system, it has not been, or has only insufficiently been, possible to control in a satisfactory manner controlled multivalue systems having interrelatinships and nonlinearities between the correcting variables and the controlled variables.

### SUMMARY

According to example embodiments of the present invention, an improved multivalue control system and an improved method for controlling a controlled multivalue system, e.g., for controlling a propeller power unit, may be provided.

According to an example embodiment of the present invention, a conversion device, when calculating the correcting variables, superimposes on the output variables of the controllers an input control component that is a function of actual values of the controlled variables. Thereby may be achieved a good decoupling of the correcting variables and the controlled variables of the controlled multivalue system which is used for compensating for the system nonlinearity.

There may be provided a first controlled variable conversion device and a second controlled variable conversion device. The output variables of the controlled multivalue system, e.g., the controlled variables, are able to be supplied to the first controlled variable conversion device as input variables, the first controlled variable conversion device ascertaining output variables, from the controlled variables, which are able to be supplied to the comparators as first input variables. Furthermore, the setpoint values of the controlled variables are able to be supplied to the second controlled variable conversion device as input variables, the second controlled variable conversion device ascertaining output variables, from the setpoint values, which are able to be supplied to the comparators as second input variables. The control result may be optimized by the controlled variable conversion, and the structure of the control may be considerably simplified.

An exemplary embodiment of the present invention is explained in greater detail with reference to the appended Figure.

### BRIEF DESCRIPTION OF THE DRAWING

FIG. 1 illustrates a closed-loop control circuit for a propeller power unit to illustrate a multivalue control system according to an example embodiment of the present invention and a method according to an example embodiment of the present invention.

### DETAILED DESCRIPTION

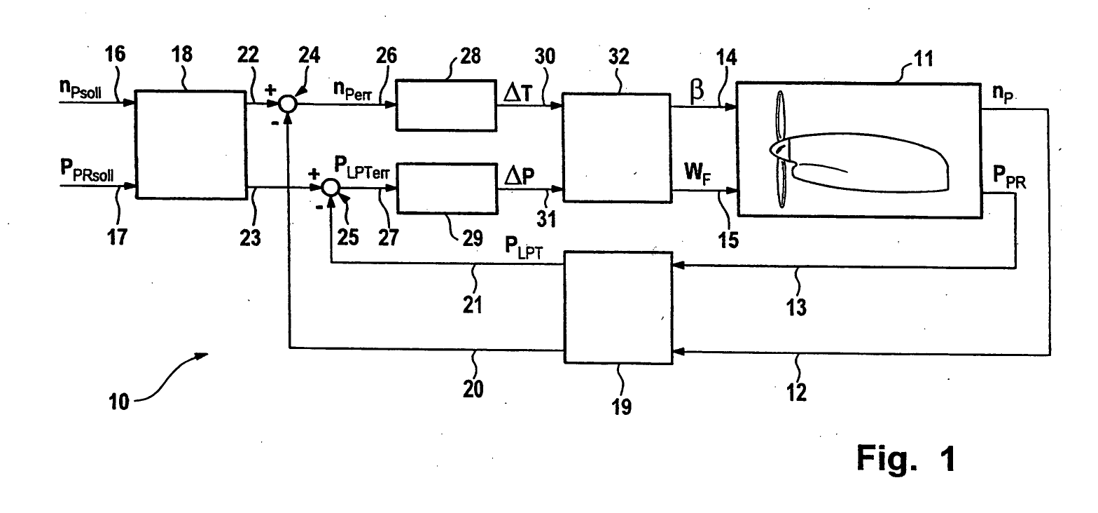

FIG. 1 illustrates a multivalue control system 10 according to an example embodiment of the present invention. In the multivalue control system 10 illustrated in FIG. 1, a controlled multivalue system 11, that is to be controlled, is arranged as a propeller power unit of an aircraft. It should be understood that example embodiments of the present invention may be applied to other controlled multivalue systems.

As illustrated in FIG. 1, in the case of the controlled multivalue system 11 arranged as a propeller power unit, a propeller speed nₚ and a propeller performance P_{PR} are to be controlled as controlled variables 12, 13. The two controlled variables 12, 13 represent the output variables of controlled multivalue system 11.

Two correcting variables 14, 15 are supplied as input variables to controlled multivalue system 11 that is arranged as a propeller power unit. In the case of first correcting variable 14, in the exemplary embodiment illustrated, a propeller blade angle of incidence β is involved. In the case of second correcting variable 15, a fuel stream w_{F} is involved.

Thus, in the case of the propeller power unit, a controlled multivalue system 11 is involved, having two input variables and two output variables. There are close interrelationships and nonlinearities between the input variables, e.g., correcting variables 14, 15 and the output variables, e.g., controlled variables 12 and 13, of the controlled multivalue system 11 arranged as a propeller power unit. With the aid of multivalue control system 10 according to an example embodiment of the present invention and the method according to an example embodiment of the present invention for controlling controlled value system 11, a solution is provided by which the interrelationships and the nonlinearities between correcting variables 14, 15 and controlled variables 12, 13 may be eliminated to the greatest extent possible, and consequently one may also achieve an optimized control result, using simple control structures, over a broad operating range of controlled multivalue system 11 that is to be controlled.

As mentioned above, the speed of the propeller nₚ is to be controlled as the first controlled variable 12, and the power of the propeller P_{PR} is to be controlled as the second controlled variable 13. Measured values of these controlled variables are designated as actual values. It is within the meaning of the control task that the actual values of controlled variables 12, 13 should be brought into agreement with corresponding setpoint values 16, 17 for the speed of the propeller and the power of the propeller. Thus FIG. 1 illustrates, as first setpoint value 16, a setpoint value for the propeller's speed n_{Psoll}, and as second setpoint value 17 a setpoint value for the power of the propeller P_{PRsoll}.

According to an example embodiment of the present invention, the actual values of controlled variables 12, 13 are not directly compared to setpoint values 16, 17 of the same. Rather, for both the actual values of controlled variables 12, 13 and for the corresponding setpoint values 16, 17, there is present in each case a controlled variable conversion device 18, 19.

A first controlled variable conversion device 19 is assigned to the measured actual values of controlled variables 12, 13. A second controlled variable conversion device 18, however, is assigned to the corresponding setpoint values 16, 17. First controlled variable conversion device 19 ascertains output variables 20, 21 from the actual values of controlled variables 12, 13. Correspondingly, second controlled variable conversion device 18 ascertains output variables 22, 23 from setpoint values 16, 17. The output variables 20, 21 of first controlled variable conversion device 19 and output variables 22, 23 of second controlled variable conversion device 18 are supplied to comparators 24, 25 as input variables. In comparators 24, 25, the corresponding output variables 20, 21, 22, 23 of controlled variable conversion devices 18, 19 are offset against one another. This is described in greater detail below.

In advance, at this point, the conversions of the actual values of controlled variables 12, 13 as well as their setpoint values 16, 17 that are executed in controlled variable conversion devices 18, 19 are described. Thus, first controlled variable conversion device 19, to which, as input variables, controlled variables 12, 13 are supplied, e.g., actual values of the propeller's speed nₚ and the propeller's power P_{PR}, makes available two output variables 20, 21, which are calculated from the input variables of controlled variable conversion device 19 and from characteristics values of controlled multivalue system 11. Thus, in the exemplary embodiment illustrated, first controlled variable conversion device 19 outputs as first output variable 20 controlled variable 12, e.g., propeller speed n_{p,}, as the first output variable. On the other hand, as second output variable 21, first controlled variable conversion device 19 outputs a quantity ascertained from the actual values of controlled variables 12, 13, e.g., in the exemplary embodiment illustrated, an ascertained value of turbine output P_{LPT}. Accordingly, propeller speed nₚ and propeller performance P_{PR} are supplied to first controlled variable conversion device 19 as input variables. As output variables 20, 21, controlled variable conversion device 19 outputs propeller speed nₚ and turbine output P_{LPT}. In order to ascertain turbine output P_{LPT} from controlled variables 12, 13, one proceeds according to the following equation:
P_{LPT}=P_{PR}+nₚ*dnₚ/dt*Θ*4π²
in which:
P_{LPT}=turbine output;
P_{PR}=propeller performance;
nₚ=propeller speed;
dnₚ/dt=first derivative of the propeller's speed; and
Θ=mass moment of inertia of the propeller power unit.

By using the above equation, output variables 20, 21 of the first controlled variable conversion device may simply be ascertained from controlled variables 12, 13 in first controlled variable conversion device 19.

In an analogous manner, the above equation is also used in second controlled variable conversion device 18, in which output variables 22, 23 are calculated from setpoint values 16, 17.

In addition, a time delay device for the setpoint value of the propeller speed is also integrated into second controlled variable conversion device 18. Output variable 22 of controlled variable conversion device 18 thus corresponds to the setpoint value for propeller speed n_{Psoll} at a time delay of, e.g., 200 milliseconds. Because of this time-delayed passing through of the setpoint value for the propeller speed, the dynamic time delaying effect of the propeller power unit is compensated for.

At this point, it is noted that output variables 20, 21 of first controlled variable conversion device 19 may also be designated as auxiliary controlled variables, and output variables 22, 23 of second controlled variable conversion device 18 may also be designated as auxiliary setpoint values.

As was mentioned above, output variables 20, 21 of first controlled variable conversion device 19 and output variables 22, 23 of second controlled variable conversion device 18 are supplied to comparators 24, 25 as input variables. As illustrated in FIG. 1, output variables 20, 22 of controlled variable conversion devices 18, 19 are supplied to a first comparator 24. In the exemplary embodiment illustrated, in this connection, the recalculated actual values and setpoint values for propeller speed nₚ are involved. In comparator 24, a difference is formed between this auxiliary setpoint value for the propeller's speed and the auxiliary actual value for the propeller's speed, and from this, a control deviation 26 for the propeller's speed is calculated. The control deviation for the propeller's speed is designated in FIG. 1 as n_{Perr}.

In analogous manner, in second comparator 25, a difference is calculated between output variable 23 of second controlled variable conversion device 18 and output variable 21 of first controlled variable conversion device 19. Accordingly, in the exemplary embodiment illustrated, in second comparator 25, a difference is ascertained between a calculated actual value of turbine output P_{LPT}, that is used as auxiliary controlled variable, and a correspondingly calculated setpoint value for this auxiliary controlled variable. A corresponding control deviation 27 between the actual value and the setpoint value of the turbine output used as auxiliary controlled variable is designated in FIG. 1 as P_{LPTerr}.

Control deviations 26, 27 of auxiliary variables 20, 21 are supplied to controllers.28, 29, as illustrated in FIG. 1. Control deviation 26 of auxiliary controlled variable 20 is supplied to first controller 28. In the case of control deviation 26 supplied to first controller 28, accordingly, a control difference is involved between auxiliary setpoint value 22 of the propeller rotational speed and auxiliary actual value 20 for the propeller speed. Accordingly, first controller 28 is arranged as a speed controller. First controller 28 ascertains an output variable 30 from control deviation 26. In the exemplary embodiment illustrated, in the case of output variable 30 a torque request ΔT is involved.

Analogously, control deviation 27 of auxiliary controlled variable 21 is supplied to second controller 29. Thus, in the case of control deviation 27, the difference is involved between setpoint value 23 and corresponding actual value 20 of turbine output P_{LPT} that is used as auxiliary controlled variable. As a result, second controller 29 is arranged as a power controller. Second controller 29 ascertains an output variable 31 from control deviation 27. In the case of output variable 31 of second controller 29, in the exemplary embodiment illustrated, a power request ΔP is involved.

The two controllers 28, 29 may be arranged, for example, as PID controllers.

Output variables 30, 31 of controllers 28, 29 are not used directly as correcting variables for controlled multivalue system 11, but are rather supplied to a conversion device 32. Output variables 30, 31 of controllers 28, 29 are accordingly used as input variables by conversion device 32. Output variables 30, 31 are offset against each other in conversion device 32. Conversion device 32 ascertains correcting variables 14, 15 for controlled multivalue system 11 from output variables 30, 31 of controllers 28, 29 and from characteristics values of controlled multivalue system 11. In the exemplary embodiment illustrated, this means that torque request ΔT and power request ΔP are supplied as input variables to conversion device 32. From these two input variables, conversion device 32 ascertains propeller blade angle of incidence β and fuel stream w_{F} as correcting variables for propeller power unit 11. In this instance, one may proceed according to the following model equations:
T=β^{E1}*nₚ^{E2}
P=w_{F}^{E3}* nₚ^{E4}
in which:
P=turbine output, output variable of speed controller;
T=torque, output variable of power controller;
nₚ=propeller speed;
w_{F}=fuel stream, the correcting variable wanted;
β=propeller blade angle of incidence, correcting variable wanted; and
E1, E2, E3, E4=exponents of the model.

According to a further aspect of an example embodiment of the present invention, in conversion device 32, for ascertaining controlled variables 14, 15, not only are output variables 30, 31 of the two controllers 28, 29 offset against one another, but rather an input control component is additionally taken into consideration in conversion device 32. Accordingly, characteristics of controlled multivalue system 11—in the current exemplary embodiment, characteristics of the turbine and of the propeller are involved—are looped into the control paths of multivalue control system 10.

In this connection, in the exemplary embodiment illustrated, characteristics maps of the propeller and the turbine are taken into consideration. Such characteristics maps are obtained from the mathematical or system-dynamic modelling of controlled multivalue system 11, in the exemplary embodiment illustrated, of the propeller power unit.

As input variables, output variables 30, 31 of the two controllers 28, 29 and, in addition, the measured corresponding actual values that are used as input control components, are supplied to these characteristics maps. In output variables 30, 31 of the two controllers 28, 29, the respective input control component is added, and this sum is supplied to the corresponding characteristics map as input variable. In this connection, the following applies:
T=f(β, nₚ, . . .) and T=ΔT+Tᵢₛₜ
P=f(w_{F}, nₚ, . . .) and P=ΔP+Pᵢₛₜ
in which:
f(β, nₚ, . . .), f(w_{F}, nₚ, . . .)=characteristics maps; and
Tᵢₛₜ,Pᵢₛₜ=input control components.

From this, it follows that:
β=f(ΔT+Tᵢₛₜ, nₚ, . . .)
w_{F=f}(ΔP+Pᵢₛₜ, nₚ, . . .)

This means that the characteristics maps are not only impinged upon by nominal or measured inputs Tᵢₛₜ and Pᵢₛₜ, but also by dynamically ascertained output variables of the two controllers 28, 29. Output variables 30, 31 of the two controllers 28, 29 are looped in by the characteristics maps of controlled multivalue system 11, and thus undergo additional conversion.

Multivalue control system 10 described herein and the method for controlling controlled multivalue system 11 includes the following three aspects:

According to a first aspect, the output variables of controlled multivalue system 11, e.g., controlled variables 12, 13 as well as corresponding setpoint values 16, 17 for controlled variables 12, 13, are recalculated in controlled variable conversion devices 18, 19 into auxiliary controlled variables 20, 21 as well as corresponding setpoint values 22, 23 for the auxiliary controlled variables. According to a second aspect, output values 30, 31 of controllers 28, 29 that are ascertained from control deviations 26, 27 of auxiliary controlled variables 20, 21 are supplied to a setpoint value conversion device 32. In conversion device 32, correcting variables 14, 15 for controlled multivalue system 11 are formed from output variables 30, 31 of controllers 28, 29. According to a third aspect, at least one input control component is superimposed on output variables 30, 31 of controllers 28, 29, in conversion device 32. This input control component is a function of the modelling of controlled multivalue system 11. In the case of the input control components, characteristics maps of controlled multivalue system 11 are involved, as the input variables for these characteristics maps the dynamically ascertained output variables 30, 31 of controllers 28, 29 and the measured corresponding actual values, so-called input control components, being used.

While using the structure of multivalue control system 10, one may, in a simple manner, eliminate interrelationships between correcting variables 14, 15 and controlled variables 12, 13 of controlled multivalue system 11, as well as nonlinearities in the dynamic behavior of controlled multivalue system 11. The multivalue control problem of controlled multivalue system 11 may thus be attributed to decoupled, linear closed-loop control circuits having one input variable as well as one output variable. Using simple control laws, such as PID controllers, one may then implement a satisfactory control of controlled multivalue system 11 over the entire operating range of controlled multivalue system 11.

Multivalue control system 10 may be used with certain advantages for controlling a propeller power unit. The pronounced nonlinearities in the dynamic transmitting behavior that occur in a propeller power unit, as well as the pronounced interrelationships between the correcting variables and the controlled variables of the propeller power unit may be easily eliminated. With the aid of the controlled variable conversion, and the correcting variable conversion, propeller speed nₚ and propeller performance P_{PR} may be controlled decoupled from each other and linearly to a great extent. Using a simple set of control parameters, an optimized control of a propeller power unit may be achieved over the entire operating range of the propeller power unit. Multivalue control system 10 may provide a robust control behavior.

### LIST OF REFERENCE NUMERALS

multivalue control system 10
controlled multivalue system 11
controlled variable 12
controlled variable 13
correcting variable 14
correcting variable 15
setpoint value 16
setpoint value 17
controlled variables conversion device 18
controlled variables conversion device 19
output variable 20
output variable 21
output variable 22
output variable 23
comparator 24
comparator 25
control deviation 26
control deviation 27
controller 28
controller 29
output variable 30
output variable 31
controlled variables conversion device 32

1-20. (canceled)

21. A multivalue control system, comprising:
a controlled multivalue system including a plurality of correcting variables as input variables and a plurality of controlled variables as output variables;
a plurality of controllers;
a plurality of comparators configured to ascertain control deviations and to supply a control deviation to each controller as an input variable; and
a conversion device, input variables of the conversion device corresponding to output variables of the controllers, the conversion device configured to calculate, at least from the output variables of the controllers, the correcting variables, the conversion device configured to superimpose, on the output variables of the controllers, an input control component that is a function of an actual value to calculate the correcting variables.

22. The multivalue control system according to claim 21, wherein the conversion device is configured to calculate the correcting values by an offset of the output variables of the controllers against each other.

23. The multivalue control system according to claim 22, wherein the conversion device is configured to offset the output variables of the controllers as a function of the controlled multivalue system.

24. The multivalue control system according to claim 21, further comprising a first controlled variable conversion device, the controlled variables arranged to be supplied to the first controlled variable conversion device as input variables, the first controlled variable conversion device configured to ascertain output variables from the controlled variables and to supply the output variables to the comparators as first input variables.

25. The multivalue control system according to claim 24, further comprising a second controlled variable conversion device, setpoint values of the controlled variables configured to be supplied to the second controlled variable conversion device as input variables, the second controlled variable conversion device configured to ascertain output values from the setpoint values and to supply the output values to the comparators as second input variables.

26. The multivalue control system according to claim 25, wherein the comparators are configured to offset the first input variables against corresponding second input variables and to supply control deviations resulting from the offset to the controllers as input variables.

27. A method for controlling a controlled multivalue system, comprising:
supplying a plurality of correcting variables to the controlled multivalue system as input variables;
offsetting a plurality of controlled variables against one another as output variables of the controlled multivalue system to ascertain control deviations;
supplying each control deviation to a controller as an input variable;
supplying output variables from the controllers to a conversion device as input variables; and
calculating the correcting variables in the conversion device at least from the output variables from the controllers, the calculating including offsetting the output variables of the controllers against each other using an input control component that is a function of an actual value.

28. The method according to claim 27, further comprising ascertaining the correcting variables in accordance with the offsetting of the output variables of the controllers against each other.

29. The method according to claim 27, further comprising:
supplying the controlled variables of the controlled multivalue system to a first controlled variable conversion device as input variables;
ascertaining output variables by the first controlled variable conversion device from the controlled variables; and
supplying the output variables ascertained by the first controlled variable conversion device to comparators as first input variables.

30. The method according to claim 29, further comprising:
supplying setpoint values of the controlled variables to a second controlled variable conversion device as input variables;
ascertaining output variables by the second controlled variable conversion device from the setpoint values; and
supplying the output variables ascertained by the second controlled variable conversion device to the comparators as second input variables.

31. The method according to claim 30, further comprising:
offsetting the first input variables of the comparators and corresponding second input variables of the comparators against each other; and
supplying control deviations resulting from the offsetting of the first input variables of the comparators and the corresponding second input variables of the comparators to the controllers as input variables.

32. A method for controlling a propeller power unit, comprising:
controlling a propeller speed and a propeller performance as controlled variables;
supplying a propeller blade angle of incidence and a fuel stream to the propeller power unit as correcting variables;
supplying output variables from controllers to a conversion device as input variables;
ascertaining, by the conversion device, the propeller blade angle of incidence and the fuel stream as the controlled variables from the output variables from the controllers;
offsetting, in the conversion device, the output variables from the controllers against each other; and
offsetting, in the conversion device, the output variables from the controllers using an input control component that is a function of an actual value.

33. The method according to claim 32, further comprising:
supplying the propeller speed and the propeller performance as the correcting variables of the propeller power unit to a first controlled variable conversion device as input variables; and
outputting, by the first controlled variable conversion device, as output variables actual values for the propeller speed and a turbine output.

34. The method according to claim 33, further comprising:
supplying setpoint values for the propeller speed and the propeller performance to a second controlled variable conversion device as input variables; and
outputting, by the second controlled variable conversion device, setpoint values for the propeller speed and the turbine output.

35. The method according to claim 34, further comprising:
ascertaining corresponding control deviations from the actual values and corresponding setpoint values for the propeller speed and the turbine output;
supplying the propeller speed control deviation to a speed controller; and
supplying the turbine output control deviation to an power controller.

36. The method according to claim 35, further comprising:
outputting a torque request as an output variable by the speed controller; and
outputting a turbine output request as an output variable by the power controller;
wherein the propeller blade angle of incidence and the fuel stream are ascertained in the propeller blade angle of incidence and the fuel stream ascertaining step in the conversion device from the torque request and the turbine output request.
